(19) United States
(12) Patent Application Publication
(10) Pub. No.: US 2016/0283963 A1
(43) Pub. Date: Sep. 29, 2016

(54) PROVIDING REAL-TIME ACCESS TO RESOURCES BASED ON DRIVING RECORD

(71) Applicants: Alexandra C. ZAFIROGLU, Portland, OR (US); Jennifer HEALEY, San Jose, CA (US); Tim PLOWMAN, Berkeley, CA (US); INTEL CORPORATION, Santa clara, CA (US)

(72) Inventors: Alexandra C. Zafiroglu, Portland, OR (US); Jennifer Healey, San Jose, CA (US); Tim Plowman, Berkeley, CA (US)

(21) Appl. No.: 14/367,980

(22) PCT Filed: Dec. 20, 2013
(86) PCT No.: PCT/US13/77054

§ 371 Date: Jun. 23, 2014

(51) Int. Cl. G06Q 30/02; H04L 29/08

(52) U.S. Cl. CPC G06Q 30/0224; H04L 67/12

(57) ABSTRACT

Various systems and methods for providing real-time access to resources based on driving record are described herein. A system to provide real-time access to resources based on a driving record comprises: a receiving module to receive vehicle operation data of a vehicle operated by a driver, the vehicle operation data related to an instance of vehicle operation; an offer module to receive an offer for the driver based on the vehicle operation data; and a presentation module to present the offer to the driver substantially concurrent to the instance of the vehicle operation.

### TECHNICAL FIELD

Embodiments described herein generally relate to driver incentives and in particular, to providing real-time access to resources based on a driving record.

### BACKGROUND

Drivers who exhibit good driving behavior may be offered discounts on insurance premiums. However, the driver may end up waiting for weeks or months to realize the benefits of the good driving behavior. The delay may be due to insurance premium change events, which may only be adjusted periodically, such as at a policy renewal.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to provide real-time access to resources based on a driving record, according to an embodiment;

FIG. 2 is a block diagram of components connected to an in-vehicle information system, according to an embodiment;

FIG. 3 is a flowchart illustrating a method for providing real-time access to resources based on a driving record, according to an embodiment; and

FIG. 4 is a block diagram illustrating an example machine upon which any one or more of the techniques (e.g., methodologies) discussed herein may perform, according to an example embodiment.

### DETAILED DESCRIPTION

Drivers may be offered various incentives for safe driving, carpooling, and limiting or time-shifting their use of congested roads. Examples include discounts for completing so called “Defensive-Driving” classes, monitoring devices from insurance companies (which may include accelerometers, GPS or other sensors) that promise potential of rate savings for safe driving, high-occupancy vehicle (HOV) lanes on highways, time of day based road tolling, and outright restrictions on road use based on vehicle license plate numbers. These incentives are not immediately available during the course of a given trip. Further, such incentives do not dynamically award access to roads and services, or discounts to driving related products and services (tolls, insurance, parking, fuel) based on current and past verified on-road behaviors of an individual driver. Instead, conventional incentives track the characteristics of the vehicle (e.g., number of occupants, license plate number, or vehicle telemetry). Such tracking is focused on a particular vehicle or how the vehicle has been driven over time—not necessarily who drove it. There are no previous solutions that incentivize individual drivers to modify their driving patterns through immediate rewards, nor are there any previous solutions that immediately reward drivers with real-time driving advantages for consistent good driving performance regardless of the vehicle they are currently driving.

The systems and methods disclosed herein include a system for linking and authenticating driver identity to vehicle use history and performance metrics, local infrastructure, and cloud based services in order to facilitate a “reward” access to transportation or vehicle-related resources such as HOV lanes, parking, discounts on insurance, etc. Other just-in-time location-based, driver-specific opportunities and information may also be provided to a driver based on driving behavior or performance (e.g., a driving record). Such a system rewards particular types of driving behavior with real-time preferential access to information, services, or resources of value to the driver.

Various sensors may be installed or used within a vehicle. Sensors include biometric sensors, which may be used to identify a driver or authenticate a driver's identity. Examples of biometric sensors include, but are not limited to facial recognition (e.g., cameras), biometric authentication (e.g., fingerprint, voiceprint, or retinal scan), pressure sensing sensors (e.g., in driver's seat or other seats), heart rate monitors, or radio-frequency (RF) sensors to sense an identification code passed via a key fob or phone app.

Sensor data analyzed either at the sensor or transmitted to the on-board system or a remote system for analysis (e.g., cloud computing platform). Sensor data or features thereof may be encrypted differently at each stage of transmission. Once the driver is authenticated, the current driving information is added to a data set and associated with that driver. In this manner, the driver's history may be saved separate from any particular car driven. As a result, incentives or other offers may be provided to the driver based on the driver's personal driving history, profile, or characteristics. In an example, the incentives or other offers may be presented on an in-vehicle information system (IVIS). For example, the IVIS may receive and display a variety of offers to the driver during the journey dependent on the driver's vehicle use history and current driving patterns including such things as following speed limits, signaling when changing lanes, etc.

As the driver operates the vehicle, data is recorded. The data may be recorded or collected by a mobile device or an IVIS. The mobile device or the IVIS may then transmit information about the driver's behavior to a cloud-based service that associates the data with the driver's identification and stores the data. This information may include, but is not limited to: speed, braking patterns, eco-driving behaviors (accelerations, coasting, etc.), signaling, lane deviation, adherence to laws (obeying speed limits, parking legally), use of mobile phone in the car, etc.

Based on the collected data, one or more offers or incentives may be presented to the driver. In an example, access to an HOV lane, select parking spaces, or express toll lanes, may be provided dynamically. For example, the IVIS or the mobile device may transmit a wireless signal to HOV lane tolls, highway or road infrastructure, or to a parking infrastructure to verify privileged access. Violations by non-privileged vehicles may be tracked by standard methods such as camera analysis and visual inspection. When special access is granted to a driver, the system may enable a government-certified “digital sticker” to become active on the vehicle. The digital sticker may allow enforcement officers to wirelessly interrogate the vehicle to verify the existence or validity of a digital sticker for access privileges. Alternatively, or in addition to the digital sticker, the system may temporarily link the license plate of the vehicle that the driver is currently driving to certain access privileges. In this case, enforcement officials (e.g., parking patrol) may verify access rights through license plate look up. This may useful when the driver has left the vehicle (e.g., left the vehicle in a parking space during work).

Other types of access and privileges may be granted. For example, a driver may receive an offer for a 10% discount on dry cleaning from a local business because their driving behavior fits within parameters for eco driving determined by the business. As another example, a driver may receive preferential access to a reserved parking space based on their exemplary record of not driving on days or times when driving is dis-incentivized. As yet another example, a driver may receive preferential access to an express toll lane based on some other aspect of their current driving behavior and/or driving history.

Thus, the systems and methods described herein provide several advantages over other systems, including incentivizing particular driving practices through real-time offers and opportunities, securely authenticating the identity of the driver, collecting and analyzing driving patterns beyond mileage, acceleration/deceleration and speed, and offering a secure platform for multiple stakeholders to offer incentives or discounts to the driver based on a driver's driving characteristics and potentially their preferences.

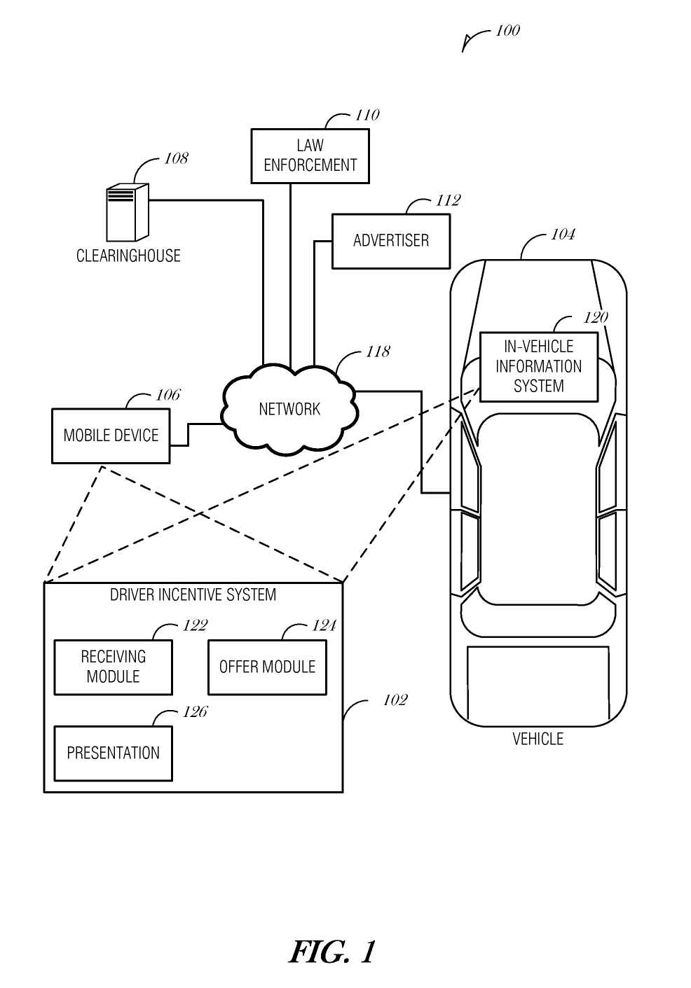

FIG. 1 is a schematic drawing illustrating a system 100 to provide real-time access to resources based on a driving record, according to an embodiment. FIG. 1 includes a driver incentive system 102, a vehicle 104, a mobile device 106, a clearinghouse 108, a law enforcement system 110, and an advertiser system 112, each communicatively coupled via a network 118.

The vehicle 104 may be of any type of vehicle, such as a commercial vehicle, consumer vehicle, or recreation vehicle. The vehicle 104 includes an in-vehicle information system (IVIS) 120, which may be connected to an on-board diagnostics system and used to record vehicle operation and other aspects of the vehicle's performance, maintenance, or status. The vehicle 104 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

The mobile device 106 may be a device such as a smartphone, cellular telephone, mobile phone, laptop computer, tablet computer, or other portable networked device. In general, the mobile device 106 is small and light enough to be considered portable and includes a mechanism to connect to a network, either over a persistent or intermittent connection.

The network 118 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 118 may include a single local area network (LAN) or wide-area network (WAN), or combinations of LANs or WANs, such as the Internet. The various devices (e.g., mobile device 106 or vehicle 104) coupled to the network 118 may be coupled to the network 118 via one or more wired or wireless connections.

In operation, the vehicle 104 is driven for a period of time, during which the IVIS 120 receives data from various on-board diagnostics systems, sensors, and the like, which sense, record, and transmit vehicle operation data. Vehicle operation data may include, but is not limited to, average fuel consumption (e.g., miles per gallon or kilometers per liter), acceleration/deceleration patterns, average vehicle speed, amount of fuel consumed, emissions, outdoor weather, road conditions, occupant information, vehicle feature use (e.g., anti-lock braking, air bag use, intermittent wipers, dynamic vehicle handling, etc.), and the like. Additional examples of vehicle operation data include performance data related to the driving of the vehicle 104. For example, speed data, g-load data, mileage data, average acceleration, average deceleration, and the like. Vehicle performance data may also include, in further examples, engine performance data, such as, oil temperature, fluid levels, cylinder temperature, spark plug voltage, fuel-air mixture, fuel flow, air pressure, boost pressure (if engine is turbocharged, or supercharged), emissions gas readings, and the like. Collectively, these may also be called vehicle performance metrics. Vehicle performance metrics may be characterized as that data that is collected by the vehicle itself during normal monitoring of its own performance. Operational data with respect to driver behavior may be collected by bolt on, or after market, installed units. Data may also be directly read from engine monitoring systems installed by the manufacturer of the vehicle by the mobile device 106 or the IVIS 120.

In an embodiment, the driver incentive system 102 includes a receiving module 122, an offer module 124, and a presentation module 126. The driver incentive system 102 operates to transmit vehicle operation data and then receive and present offers to the driver based on the vehicle's operation. The driver incentive system 102 may be incorporated in the mobile device 106 or the IVIS 120. For example, the mobile device 106 may have an application (“app”) that the user/driver may use to collect information from the IVIS 120 or other on-board system in the vehicle 104. The app may then present an offer to the user in one of several ways, such as with video, audio, text message, email, web page, or the like. Similarly, the IVIS 120 may be equipped with a display (e.g., a liquid crystal display (LCD)) in the dash of the vehicle 104, which may present navigation, radio, or other entertainment or vehicle information. The IVIS 120 may incorporate a driver incentive system 102 as an application that executes on the IVIS 120 and transmits and receives vehicle operation data and offers, respectively.

Additionally, the mobile device 106 may work in conjunction with the IVIS 120 to implement a driver incentive system 102. For example, the mobile device 106 may be used as the communication conduit to provide long-range communication channel (e.g., 2G/3G or LTE). The IVIS 120 may be used to collect the vehicle operation data and display the offer, communicating with the mobile device 106 over a short-range communication channel (e.g., Bluetooth).

The vehicle operational data is transmitted to a clearinghouse 108, which maintains the driver's driving habits or other aspects of vehicle operation. The clearinghouse 108 may also include one or more offers, which may be provided by the advertiser system 112. The offers may include various incentives or rewards, such as discounts, coupons, rebates, or other monetary rewards to goods or services. The offers may also include various access rights, such as access to a restricted driving lane, an express toll, or a reserved parking space.

Advertisers may access the clearinghouse 108 via their respective advertiser system 112 and upload text, video, audio, or other multimedia to be served to a driver via the driver incentive system 102. An advertiser may also define one or more rules or criteria, identifying which offers should be served to which drivers. The rules or criteria may be stored in a rules database at the clearinghouse 108 and referenced by the clearinghouse 108 when a driver incentive system 102 uploads vehicle operation data. Offers may also be associated with rules that define when an offer is provided, such as a seasonal offer, an offer only good during a particular time of day or day of week, or other time-restricted or number-restricted criteria. For example, an offer may only be provided to a certain number of drivers. If every driver were allowed to drive in the HOV lane, then the HOV lane may become as congested as the regular lanes. Thus, an offer to drive in the HOV lane may be restricted by time or numbers to manage flow.

The law enforcement system 110 may be installed or incorporated into a law enforcement officer's vehicle (e.g., a cruiser) or be embedded in intelligent transportation systems (ITS) such as road monitoring cameras, smart intersections, or toll booths. Using cameras or manual entry, the law enforcement officer may transmit a license plate number or some other identifying information to the clearinghouse 108 to determine whether a particular vehicle is allowed to operate in a particular manner. For example, a vehicle occupied by only the driver may typically be prohibited from driving in an HOV lane. However, because the driver has satisfied one or more rules, an offer was extended to the driver via the driver incentive system 102 to allow the driver to drive in the HOV lane. When a law enforcement officer observes the driver, the law enforcement officer may first refer to the clearinghouse 108 to determine whether the driver is operating the vehicle 104 with some limited or temporary permissions. The law enforcement system 110 may capture the vehicle's license plate number, transmit the plate number to the clearinghouse 108, and receive one or more temporary access rights available to the driver/vehicle. This check may be performed automatically by an in-vehicle law enforcement system. Similarly, when cruising a parking lot, the law enforcement system 110 may capture plate numbers and run them through the clearinghouse 108 to verify whether vehicles parked in restricted spaces should be permitted to be there.

Returning to the driver incentive system 102, the receiving module 122 is operable to receive vehicle operation data of a vehicle 104 operated by a driver, the vehicle operation data related to an instance of vehicle operation. In an embodiment, the instance of vehicle operation comprises a trip where the vehicle 104 was used. In various embodiments, the vehicle operation data comprises a vehicle performance metric or an environmental metric. The vehicle performance metric may comprise a vehicle speed, fuel efficiency, an acceleration, a deceleration, an amount noise generated, or an amount of pollution generated. The environmental metric may comprise a number of occupants in the vehicle, a condition of the road that the vehicle 104 has travelled over, an outside temperature, a weather metric that the vehicle 104 was operated in, or a route that the vehicle 104 was driven. The vehicle operation data may be received directly from the vehicle 104. In an alternative embodiment, to receive vehicle operation data for the vehicle, the receiving module 122 is to receive the vehicle operation data from a user device (e.g., mobile device 102), which obtained the vehicle operation data when communicatively connected to the vehicle 104 (e.g., via the IVIS 120). The vehicle 104 may be any type of vehicle, including but not limited to a car, a truck, a motorcycle, a boat, or a recreational vehicle.

In an embodiment, the vehicle operation data is received from a sensor installed in or on the vehicle 104. In various embodiments, the sensor comprises an accelerometer, gyrometer, steering wheel sensor, brake sensor, turn signal sensor, or a camera, any number of cameras or any sensor attached to any of the vehicle's internal busses such as the CAN bus or high speed ADAS bus.

The offer module 124 is operable to receive an offer for the driver based on the vehicle operation data. To receive the offer, the offer module 124 may be operable to access a clearinghouse of offers for drivers, the offers available to drivers based on particular traits of the drivers. The offer module 124 may then transmit the vehicle operation data and an identification of the driver. The identification of the driver may be obtained from various sensors or provided by the driver via an input mechanism, such as the IVIS 120. The offer module 124 then receives the offer from the clearinghouse 108 based on the vehicle operation data and the identification of the driver.

The offer may be a coupon or an access right to a resource in geographic proximity to the vehicle 104. Geographic proximity may be measured in miles (e.g., within 5 miles of the vehicle 104) or similar or smaller units (e.g. kilometers, feet, meters) and may include directionality (e.g. in front of the driver in the direction of travel). For example, a coupon for a discounted tire rotation may be presented to the driver from a service station that is three miles away. As another example, the driver may be provided a temporary permit to drive in an HOV lane that is adjacent to the lane that they are currently driving in. Thus, geographic proximity is relative to the type of service or access provided. Further, the driver's identity may be used to personalize offers. Thus, in an embodiment, the coupon for the discount for the business is personalized to the driver.

In an embodiment, the resource comprises a parking space, and the access right comprises use of the parking space. In an embodiment, the resource comprises a high-occupancy vehicle lane, and the access right comprises use of the high-occupancy vehicle lane. In an embodiment, the resource comprises a toll lane, and the access right comprises use of the toll lane.

The presentation module 126 is operable to present the offer to the driver substantially concurrent to the instance of the vehicle operation. In an embodiment, to present the offer to the driver, the presentation module 126 is to present the offer to the driver via a mobile device 106. In an embodiment, to present the offer to the driver, the presentation module 126 is to present the offer to the driver via the in-vehicle information system 120.

Presenting the offer while the driver is in the vehicle 104 or soon after is advantageous to provide the driver an immediate reward for current good driving behavior. Some offers may be based on past driving history in combination with current driving operation. For example, a person who habitually follows at least 100 feet behind the vehicle in front may be provided some offer for a vehicle-related service for being a habitually safe driver. The offer may be presented to the driver after 50 hours of driving in this manner.

In generally, “substantially concurrent” refers to a period while the driver is operating the vehicle 104 or some time close to the time of operation, either before or after operation. In an embodiment, substantially concurrent to the instance of the vehicle operation comprises during the instance of the vehicle operation. In another embodiment, substantially concurrent to the instance of the vehicle operation comprises within an hour after the instance of the vehicle operation. The time period may be some time before or after operation of the vehicle 104. The time period may vary based on the type of offer.

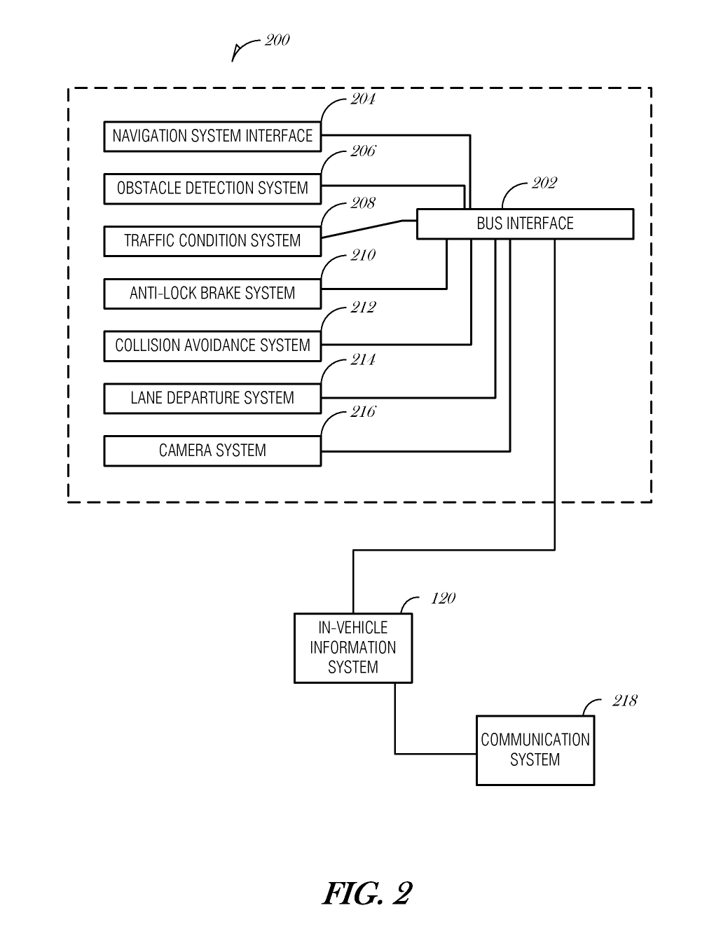

FIG. 2 is a block diagram of components 200 connected to an in-vehicle information system 120, according to an embodiment. As shown the components 200 include a series of subsystems and interfaces. One of these interfaces, the bus interface 202, is operably connected with an IVIS 120. The bus interface 202 may be a controller area network bus (CAN bus) or an ADAS (Advanced Driver Assistance System) bus. A navigation system interface 204 enables the access to location coordinates and information from the navigation system through the bus interface 202.

Safety-related subsystems may include an obstacle detection system 206, a traffic condition system 208, an anti-lock brake system 210, a collision avoidance system 212, a lane departure system 214, and a camera system 216. Each of these subsystems may provide guidance to motor vehicle operators or internal vehicle operation systems. Other types of detection subsystems may also be used and deployed within the components 200.

The IVIS 120 is connected to the components 200 through the bus interface 202 and may be used to collect and obtain event data (including location coordinates from navigation system interface 204) from a variety of motor vehicle subsystems. The IVIS 120 is further operably coupled to a communication system 218, which enables the communication and exchange of data and associated information to a processing system or service (using the communication networks and techniques illustrated in FIG. 1, for example).

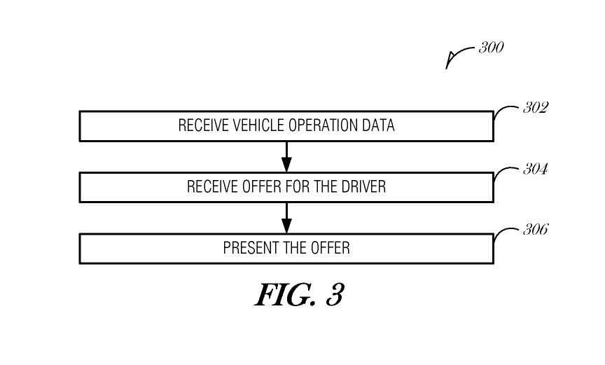

FIG. 3 is a flowchart illustrating a method 300 for providing real-time access to resources based on a driving record, according to an embodiment. At 302, vehicle operation data of a vehicle operated by a driver is received. The vehicle operation data is related to an instance of vehicle operation. In an embodiment, the vehicle operation data comprises a vehicle performance metric or an environmental metric. In an embodiment, the vehicle performance metric comprises a vehicle speed, fuel efficiency, an acceleration, a deceleration, an amount noise generated, or an amount of pollution generated. In an embodiment, the environmental metric comprises a number of occupants in the vehicle, a condition of the road that the vehicle has travelled over, an outside temperature, a weather metric that the vehicle was operated in, or a route that the vehicle was driven.

The instance of vehicle operation may be as short as a trip to the corner store or as long as a trip across country. In an embodiment, the instance of vehicle operation comprises a trip where the vehicle was used.

In an embodiment, the vehicle operation data is received from a sensor installed on the vehicle. In various embodiments, the sensor comprises an accelerometer, gyrometer, steering wheel sensor, brake sensor, turn signal sensor, or a camera.

At 304, an offer for the driver based on the vehicle operation data is received. In an embodiment, receiving the offer comprises accessing a clearinghouse of offers for drivers, the offers available to drivers based on particular traits of the drivers. The vehicle operation data and an identification of the driver may be transmitted to the clearinghouse and then the offer is received from the clearinghouse based on the vehicle operation data and the identification of the driver.

In an embodiment, the offer comprises a coupon or an access right to a resource in geographic proximity to the vehicle. In an embodiment, the coupon comprises a discount for a business in geographic proximity to the vehicle. In an embodiment, the coupon for the discount for the business is personalized to the driver.

In an embodiment, the resource comprises a parking space, and the access right comprises use of the parking space. In an embodiment, the resource comprises a high-occupancy vehicle lane, and the access right comprises use of the high-occupancy vehicle lane. In an embodiment, the resource comprises a toll lane, and the access right comprises use of the toll lane.

At 306, the offer is presented to the driver substantially concurrent to the instance of the vehicle operation. In an embodiment, presenting the offer to the driver comprises presenting the offer to the driver via a mobile device. In an embodiment, presenting the offer to the driver comprises presenting the offer to the driver via an in-vehicle information system.

In an embodiment, substantially concurrent to the instance of the vehicle operation comprises during the instance of the vehicle operation. In an embodiment, substantially concurrent to the instance of the vehicle operation comprises within an hour after the instance of the vehicle operation.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

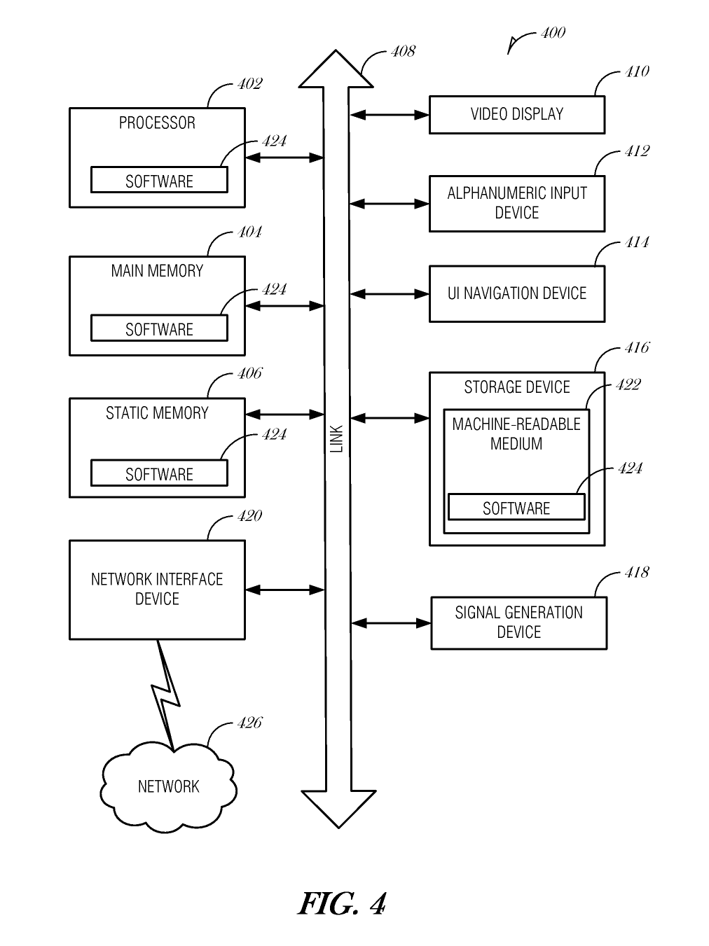

FIG. 4 is a block diagram illustrating a machine in the example form of a computer system 400, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter (such as a device, apparatus, or machine) comprising a system to provide real-time access to resources based on a driving record, comprising: a receiving module to receive vehicle operation data of a vehicle operated by a driver, the vehicle operation data related to an instance of vehicle operation; an offer module to receive an offer for the driver based on the vehicle operation data; and a presentation module to present the offer to the driver substantially concurrent to the instance of the vehicle operation.

In Example 2, the subject matter of Example 1 may optionally include, wherein the vehicle operation data comprises a vehicle performance metric or an environmental metric.

In Example 3, the subject matter of any one or more of Examples 1 to 2 may optionally include, wherein the vehicle performance metric comprises a vehicle speed, fuel efficiency, an acceleration, a deceleration, an amount noise generated, or an amount of pollution generated.

In Example 4, the subject matter of any one or more of Examples 1 to 3 may optionally include, wherein the environmental metric comprises a number of occupants in the vehicle, a condition of the road that the vehicle has travelled over, an outside temperature, a weather metric that the vehicle was operated in, or a route that the vehicle was driven.

In Example 5, the subject matter of any one or more of Examples 1 to 4 may optionally include, wherein the instance of vehicle operation comprises a trip where the vehicle was used.

In Example 6, the subject matter of any one or more of Examples 1 to 5 may optionally include, wherein the vehicle operation data is received from a sensor installed on the vehicle.

In Example 7, the subject matter of any one or more of Examples 1 to 6 may optionally include, wherein the sensor comprises an accelerometer, gyrometer, steering wheel sensor, brake sensor, turn signal sensor, or a camera.

In Example 8, the subject matter of any one or more of Examples 1 to 7 may optionally include, wherein to receive the offer, the offer module is to: access a clearinghouse of offers for drivers, the offers available to drivers based on particular traits of the drivers; transmit the vehicle operation data and an identification of the driver; and receive the offer from the clearinghouse based on the vehicle operation data and the identification of the driver.

In Example 9, the subject matter of any one or more of Examples 1 to 8 may optionally include, wherein the offer comprises a coupon or an access right to a resource in geographic proximity to the vehicle.

In Example 10, the subject matter of any one or more of Examples 1 to 9 may optionally include, wherein the coupon comprises a discount for a business in geographic proximity to the vehicle.

In Example 11, the subject matter of any one or more of Examples 1 to 10 may optionally include, wherein the coupon for the discount for the business is personalized to the driver.

In Example 12, the subject matter of any one or more of Examples 1 to 11 may optionally include, wherein the resource comprises a parking space, and wherein the access right comprises use of the parking space.

In Example 13, the subject matter of any one or more of Examples 1 to 12 may optionally include, wherein the resource comprises a high-occupancy vehicle lane, and wherein the access right comprises use of the high-occupancy vehicle lane.

In Example 14, the subject matter of any one or more of Examples 1 to 13 may optionally include, wherein the resource comprises a toll lane, and wherein the access right comprises use of the toll lane.

In Example 15, the subject matter of any one or more of Examples 1 to 14 may optionally include, wherein to present the offer to the driver, the presentation module is to present the offer to the driver via a mobile device.

In Example 16, the subject matter of any one or more of Examples 1 to 15 may optionally include, wherein to present the offer to the driver, the presentation module is to present the offer to the driver via an in-vehicle information system.

In Example 17, the subject matter of any one or more of Examples 1 to 16 may optionally include, wherein substantially concurrent to the instance of the vehicle operation comprises during the instance of the vehicle operation.

In Example 18, the subject matter of any one or more of Examples 1 to 17 may optionally include, wherein substantially concurrent to the instance of the vehicle operation comprises within an hour after the instance of the vehicle operation.

Example 19 includes subject matter for providing real-time access to resources based on a driving record (such as a method, means for performing acts, machine readable medium including instructions that when performed by a machine cause the machine to performs acts, or an apparatus configured to perform) comprising: receiving vehicle operation data of a vehicle operated by a driver, the vehicle operation data related to an instance of vehicle operation; receiving an offer for the driver based on the vehicle operation data; and presenting the offer to the driver substantially concurrent to the instance of the vehicle operation.

In Example 20, the subject matter of Example 19 may optionally include, wherein the vehicle operation data comprises a vehicle performance metric or an environmental metric.

In Example 21, the subject matter of any one or more of Examples 19 to 20 may optionally include, wherein the vehicle performance metric comprises a vehicle speed, fuel efficiency, an acceleration, a deceleration, an amount noise generated, or an amount of pollution generated.

In Example 22, the subject matter of any one or more of Examples 19 to 21 may optionally include, wherein the environmental metric comprises a number of occupants in the vehicle, a condition of the road that the vehicle has travelled over, an outside temperature, a weather metric that the vehicle was operated in, or a route that the vehicle was driven.

In Example 23, the subject matter of any one or more of Examples 19 to 22 may optionally include, wherein the instance of vehicle operation comprises a trip where the vehicle was used.

In Example 24, the subject matter of any one or more of Examples 19 to 23 may optionally include, wherein the vehicle operation data is received from a sensor installed on the vehicle.

In Example 25, the subject matter of any one or more of Examples 19 to 24 may optionally include, wherein the sensor comprises an accelerometer, gyrometer, steering wheel sensor, brake sensor, turn signal sensor, or a camera.

In Example 26, the subject matter of any one or more of Examples 19 to 25 may optionally include, wherein receiving the offer comprises: accessing a clearinghouse of offers for drivers, the offers available to drivers based on particular traits of the drivers; transmitting the vehicle operation data and an identification of the driver; and receiving the offer from the clearinghouse based on the vehicle operation data and the identification of the driver.

In Example 27, the subject matter of any one or more of Examples 19 to 26 may optionally include, wherein the offer comprises a coupon or an access right to a resource in geographic proximity to the vehicle.

In Example 28, the subject matter of any one or more of Examples 19 to 27 may optionally include, wherein the coupon comprises a discount for a business in geographic proximity to the vehicle.

In Example 29, the subject matter of any one or more of Examples 19 to 28 may optionally include, wherein the coupon for the discount for the business is personalized to the driver.

In Example 30, the subject matter of any one or more of Examples 19 to 29 may optionally include, wherein the resource comprises a parking space, and wherein the access right comprises use of the parking space.

In Example 31, the subject matter of any one or more of Examples 19 to 30 may optionally include, wherein the resource comprises a high-occupancy vehicle lane, and wherein the access right comprises use of the high-occupancy vehicle lane.

In Example 32, the subject matter of any one or more of Examples 19 to 31 may optionally include, wherein the resource comprises a toll lane, and wherein the access right comprises use of the toll lane.

In Example 33, the subject matter of any one or more of Examples 19 to 32 may optionally include, wherein presenting the offer to the driver comprises presenting the offer to the driver via a mobile device.

In Example 34, the subject matter of any one or more of Examples 19 to 33 may optionally include, wherein presenting the offer to the driver comprises presenting the offer to the driver via an in-vehicle information system.

In Example 35, the subject matter of any one or more of Examples 19 to 34 may optionally include, wherein substantially concurrent to the instance of the vehicle operation comprises during the instance of the vehicle operation.

In Example 36, the subject matter of any one or more of Examples 19 to 35 may optionally include, wherein substantially concurrent to the instance of the vehicle operation comprises within an hour after the instance of the vehicle operation.

Example 37 includes a machine-readable medium including instructions for providing real-time access to resources based on driving record, which when executed by a machine, cause the machine to perform operations of any of the Examples 1-36.

Example 38 includes an apparatus comprising means for performing any of the Examples 1-36.

Example 39 includes an apparatus to provide real-time access to resources based on a driving record, the apparatus comprising: means for receiving vehicle operation data of a vehicle operated by a driver, the vehicle operation data related to an instance of vehicle operation; means for receiving an offer for the driver based on the vehicle operation data; and means for presenting the offer to the driver substantially concurrent to the instance of the vehicle operation.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. A machine-readable medium including instructions for providing real-time access to resources based on driving record, which when executed by a machine, cause the machine to:
receive vehicle operation data of a vehicle operated by a driver, the vehicle operation data related to an instance of vehicle operation;
receive an offer for the driver based on the vehicle operation data; and
present the offer to the driver substantially concurrent to the instance of the vehicle operation.

27. The machine-readable medium of claim 26, wherein the vehicle operation data comprises a vehicle performance metric or an environmental metric.

28. The machine-readable medium of claim 27, wherein the vehicle performance metric comprises a vehicle speed, fuel efficiency, an acceleration, a deceleration, an amount noise generated, or an amount of pollution generated.

29. The machine-readable medium of claim 27, wherein the environmental metric comprises a number of occupants in the vehicle, a condition of the road that the vehicle has travelled over, an outside temperature, a weather metric that the vehicle was operated in, or a route that the vehicle was driven.

30. The machine-readable medium of claim 26, wherein the vehicle operation data is received from a sensor installed on the vehicle.

31. The machine-readable medium of claim 26, wherein the instructions to receive the offer comprise instructions to:
access a clearinghouse of offers for drivers, the offers available to drivers based on particular traits of the drivers;
transmit the vehicle operation data and an identification of the driver; and
receive the offer from the clearinghouse based on the vehicle operation data and the identification of the driver.

32. The machine-readable medium of claim 26, wherein the offer comprises a coupon or an access right to a resource in geographic proximity to the vehicle.

33. The machine-readable medium of claim 32, wherein the coupon comprises a discount for a business in geographic proximity to the vehicle.

34. The machine-readable medium of claim 33, wherein the coupon for the discount for the business is personalized to the driver.

35. The machine-readable medium of claim 32, wherein the resource comprises a parking space, and wherein the access right comprises use of the parking space.

36. The machine-readable medium of claim 32, wherein the resource comprises a high-occupancy vehicle lane, and wherein the access right comprises use of the high-occupancy vehicle lane.

37. The machine-readable medium of claim 26, wherein the instructions to present the offer to the driver comprise instructions to present the offer to the driver via a mobile device.

38. The machine-readable medium of claim 26, wherein the instructions to present the offer to the driver comprise instructions to present the offer to the driver via an in-vehicle information system.

39. The machine-readable medium of claim 26, wherein substantially concurrent to the instance of the vehicle operation comprises during the instance of the vehicle operation.

40. A system to provide real-time access to resources based on a driving record, the system comprising:
a receiving module to receive vehicle operation data of a vehicle operated by a driver, the vehicle operation data related to an instance of vehicle operation;
an offer module to receive an offer for the driver based on the vehicle operation data; and
a presentation module to present the offer to the driver substantially concurrent to the instance of the vehicle operation.

41. The system of claim 40, wherein the vehicle operation data comprises a vehicle performance metric or an environmental metric.

42. The system of claim 40, wherein to receive the offer, the offer module is to:
access a clearinghouse of offers for drivers, the offers available to drivers based on particular traits of the drivers;
transmit the vehicle operation data and an identification of the driver; and
receive the offer from the clearinghouse based on the vehicle operation data and the identification of the driver.

43. A method for providing real-time access to resources based on a driving record, the method comprising:
receiving vehicle operation data of a vehicle operated by a driver, the vehicle operation data related to an instance of vehicle operation;
receiving an offer for the driver based on the vehicle operation data; and
presenting the offer to the driver substantially concurrent to the instance of the vehicle operation.

44. The method of claim 43, wherein receiving the offer comprises:
accessing a clearinghouse of offers for drivers, the offers available to drivers based on particular traits of the drivers;
transmitting the vehicle operation data and an identification of the driver; and
receiving the offer from the clearinghouse based on the vehicle operation data and the identification of the driver.

45. The method of claim 43, wherein substantially concurrent to the instance of the vehicle operation comprises within an hour after the instance of the vehicle operation.
